(19) United States
(12) Patent Application Publication
(10) Pub. No.: US 2012/0262763 A1
(43) Pub. Date: Oct. 18, 2012

(54) AUTOMATICALLY-ACTIVATED IMAGE SCANNING DEVICE

(76) Inventors: Tien-Chi TANG, Science-Based Industrial Park (TW); Huei-Chuan Tai, Science-Based Industrial Park (TW)

(21) Appl. No.: 13/088,882

(22) Filed: Apr. 18, 2011

(51) Int. Cl. H04N 1/32

(52) U.S. Cl. 358/448

(57) ABSTRACT

An automatically-activated image scanning device includes a platform, a light source, an image sensor, a driving unit and a controller. The platform is configured for supporting an object. The light source is configured for providing illuminating light. The image sensor is configured for capturing reflected light from the object reflecting the illuminating light and outputting an image signal. The driving unit is configured for driving the image sensor to move relative to the object. The controller is configured for analyzing the image signal to determine existence of the object on the platform and then activate a scanning process if the existence of said object is determined.

### BACKGROUND OF THE INVENTION

1. Field of the Invention

The present invention relates to an image scanning device, and more particularly to an automatically-activated image scanning device.

2. Description of the Prior Art

A conventional image scanning device activates a scanning process by pressing a button disposed on the device or utilizing software installed in a computer, resulting in complicated activating procedures for the scanning process. For users who need to digitalize a large amount of documents, scanning efficiency is hindered as the scanning process is not able to be activated automatically.

A conventional image scanning device configured with a switch or a sensor is able to scan automatically when an upper lid of the image scanning device is detected to be closed. However, the addition of the switch or sensor increases the manufacturing cost, besides, scanning process cannot be activated until the user closed the upper lid, resulting that scanning efficiency is still not promising.

In summary, it is highly desirable to provide an image scanning device simplifying the activating procedure for the scanning process and also being able to automatically scan without disposing additional hardware.

### SUMMARY OF THE INVENTION

The present invention is directed to an automatically-activated image scanning device which is configured with an image sensor to capture images on a platform and the captured images are analyzed to determine existence of the object on the platform. A scanning process will be automatically activated when the existence of the object on the platform is determined.

According to an embodiment, the automatically-activated image scanning device includes a platform, a light source, an image sensor, a driving unit and a controller. The platform is configured for supporting an object. The light source is disposed at one side of the platform for providing illuminating light. The image sensor is configured for capturing reflected light of the illuminating light from the object and outputting an image signal. The driving unit is configured for driving the image sensor to move relative to the object. The controller is electrically connected to the image sensor and the driving unit and is configured for analyzing the image signal to determine existence of the object on the platform and then activate a scanning process if the existence of said object is determined.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a schematic diagram illustrating the automatically-activated image scanning device according to an embodiment of the present invention;

FIG. 2a and FIG. 2b are diagrams illustrating layouts of sensing sections of the image sensor of the automatically-activated image scanning device according to an embodiment of the present invention; and

FIG. 3 is a flow chart illustrating a scanning flow of the automatically-activated image scanning device according to an embodiment of the present invention.

### DESCRIPTION OF THE PREFERRED EMBODIMENT

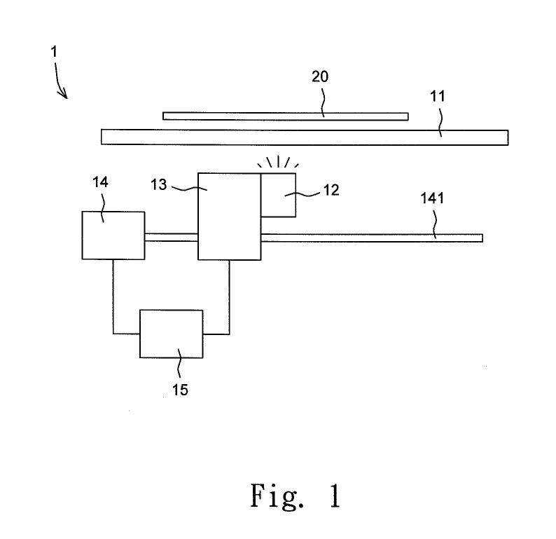

Referring to FIG. 1, an automatically-activated image scanning device 1 according to the present invention includes a platform 11, a light source 12, an image sensor 13, a driving unit 14 and a controller 15. The platform 11 is configured for supporting an object 20, such as a document, a book and etc. The light source 12 is disposed at one side of the platform 11 for providing illuminating light, for example, the light source 12 may include a light emitting diode (LED) or a cold cathode fluorescent lamp (CCFL). The image sensor 13 is configured for capturing reflected light from the object 20 and then outputting an image signal, when the object 20 is illuminated by the illuminating light from the light source 12. For example, the image sensor 13 may include a charge-coupled device (CCD) sensor, a complementary metal-oxide-semiconductor (CMOS) sensor or a contact image sensor (CIS).

According to one embodiment of the present invention, the platform 11 may be made of transparent material. The light source 12 and the image sensor 13 may be disposed below the platform 11. The illuminating light from the light source 12 may transmit through the platform 11 to illuminate the surface of the object 20. The illuminating light is then reflected by the surface of the object 20 and captured by the image sensor 13. It is noted that the light source 12 and the image sensor 13 may also be disposed above the platform 11, which is still within the spirit and scope of the present invention.

The driving unit 14 is electrically connected to the image sensor 13, for driving the image sensor 13 to move relative to the object 20 for achieving larger scanning area. For example, the image sensor 13 is driven by the driving unit 14 to move along the rail 141 thereby being able to capture the entire image of the object 20. It is noted that the driving unit 14 may be electrically connected to the platform 1 land the platform 11 may move relative to the image sensor 13 so as to achieve larger scanning area.

The controller 15 is electrically connected to the image sensor 13 and the driving unit 14 and configured for controlling the image sensor 13 and the driving unit 14 to activate scanning process. Furthermore, the controller 15 is configured for analyzing the image signal captured by the image sensor 13 to determine the existence of the object 20 to be scanned. A scanning process is activated by the controller 15 in the case of the existence of the object 20. The scanning process includes image preview, image scan, scanning parameter set up and etc.

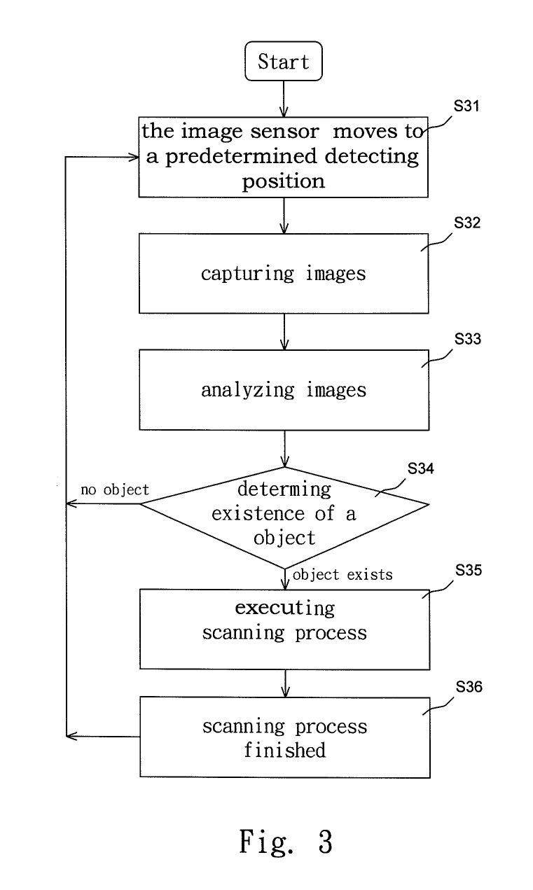

Referring to FIG. 3, FIG. 3 is a scanning flow utilizing the image scanning device 1 according to one embodiment of the present invention. First, the image sensor 13 moves to a predetermined detecting position (S31) when the image scanning device 1 is turned on or the scanning mode is switched from manual mode to auto-scan mode, followed by capturing image (S32). The controller 15 analyzes the image signal by the image sensor 13 (S33) to determine the existence of the object 20 on the platform 11 (S34). The image sensor 13 will remain at the predetermined detecting position to continue to capture image if there is no object 20 on the platform 11. The controller 15 activates the image sensor 13 and the driving unit 14 to execute scanning process in the case of the existence of the object 20 on the platform 11 (S35). After the scanning process is completed (S36), the image sensor 13 moves back to the predetermined detecting position (S31) and captures the other image for analysis by the controller 15.

In one embodiment of the present invention, the existence of the object 20 on the platform 11 is determined by the controller 15 based on the brightness variation of one or several captured images. For example, the light source 12 emits steady light when the image sensor 13 captures image at the predetermined detecting position. When the object 20 is disposed on the platform 11, the illuminating light is reflected by the object 20, resulting in brightness variation. The existence of the object 20 on the platform 11 is determined when the brightness variation exceeds a predetermined value lasts longer than a predetermined period, and then scanning process is activated by the controller 15. In one embodiment of the present invention, the light source 12 emits blinking light when the image sensor 13 captures image at the predetermined detecting position. Brightness variation detected by the image sensor 13 is fairly small when the object 20 is not disposed on the platform 11. The object 20 is determined to be existent on the platform 11 when brightness variation of the image signal is regular, and then scanning process is then activated by the controller 15.

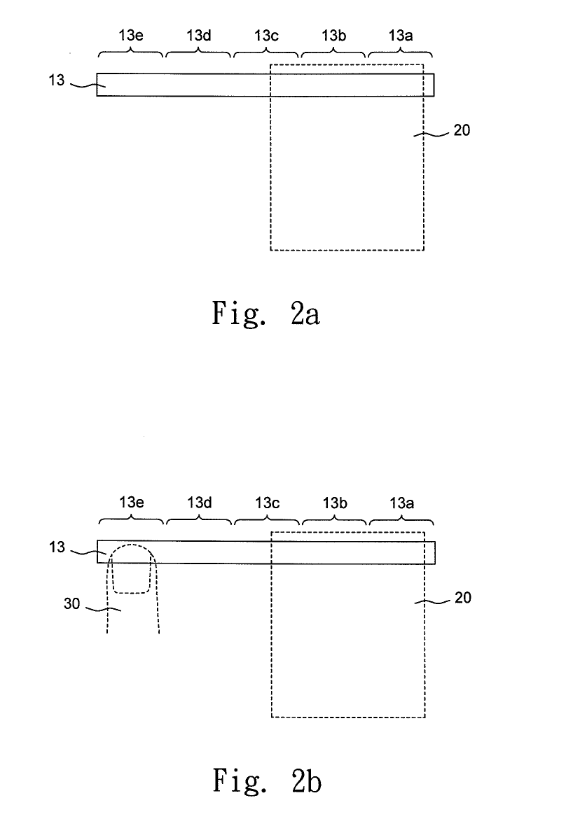

Referring to FIG. 2a, in one embodiment of the present invention, the image sensor 13 is divided into a plurality of sensing sections 13a to 13e by the controller 15 and brightness variation in image signals detected by each of the sensing sections 13a to 13e is respectively analyzed by the controller 15. For example, as the object 20 is disposed within sensing ranges of the sensing sections 13a, 13b and 13c, the brightness of images captured by the sensing sections 13a, 13b and 13c are different from that of images captured by the sensing sections 13d and 13e. Therefore, the controller 15 is able to determine the existence of the object 20 within the sensing ranges of the sensing sections 13a, 13b and 13c, and then scanning process is activated by the controller 15. In one embodiment of the present invention, the existence of the object 20 on the platform 11 is determined only if the amount of the sensing sections 13a to 13e capturing the image of the object 20 exceeds a predetermined number, thereby avoiding misjudgment, such as brightness variation caused by an item of miscellany having volume smaller than a predetermined value and fallen in the sensing ranges.

Referring to FIG. 2b, in one embodiment, the image sensor 13 is divided into a plurality of sensing sections 13a to 13e by the controller 15. The controller 15 is able to not only determine the existence of the object 20 on the platform 11 according to the brightness variation of images captured by each sensing section 13a to 13e, but also execute operations corresponding to the brightness variation of images captured in sensing sections 13a to 13e, respectively. For example, brightness variation of images captured by the sensing section 13e is detected when a user puts his/her finger 30 within the sensing range of sensing section 13e and then the controller 15 executes the corresponding operation, such as scanning mode setup (black-white/gray level/color scanning), resolution setup, manual/automatic scan switching and etc. In other words, sensing sections 13a to 13e under appropriate layout may be configured as operational interface. It is noted that the dimension or the location of sensing sections 13a to 13e may be adjusted depending on practical needs. Besides, the image sensor 13 includes a dot-shaped, a line-shaped, a line-shaped, a plane-shaped or an irregular shaped configuration.

To sum up, the automatically-activated image scanning device according to the present invention utilizes the image sensor to capture images on the platform and activates scanning process according to the result of analyzing the existence of the object on the platform. No additional hardware is disposed in the automatically-activated image scanning device according to the present invention, thereby lowering manufacturing cost, simplifying operating procedure and improving scanning efficiency.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An automatically-activated image scanning device, comprising:
a platform configured for supporting an object;
a light source disposed at one side of said platform for providing illuminating light;
an image sensor configured for capturing reflected light of said illuminating light from said object and outputting an image signal;
a driving unit configured for driving said image sensor to move relative to said object; and
a controller electrically connected to said image sensor and said driving unit and configured for analyzing said image signal to determine existence of said object on said platform and activating a scanning process in the case of the existence of said object.

2. The automatically-activated image scanning device according to claim 1, wherein said image sensor are divided into a plurality of sensing sections by said controller and existence of said object is determined based on the amount of said sensing sections capturing the image of said object exceeding a predetermined number.

3. The automatically-activated image scanning device according to claim 1, wherein said image sensor are divided into a plurality of sensing sections by said controller for user to proceed corresponding operation by adjusting said image signal detected by a predetermined sensing section.

4. The automatically-activated image scanning device according to claim 1, wherein said image sensor detects said reflected light for one or several times for said controller to determine the existence of said object on said platform.

5. The automatically-activated image scanning device according to claim 1, wherein said light source emits steady light or blinking light.

6. The automatically-activated image scanning device according to claim 1, wherein said light source comprises a light emitting diode (LED) or a cold cathode fluorescent lamp (CCFL).

7. The automatically-activated image scanning device according to claim 1, wherein said image sensor is disposed below said platform and said platform is made of transparent material.

8. The automatically-activated image scanning device according to claim 1, wherein said image sensor comprises a dot-shaped, a line-shaped, a line-shaped, a plane-shaped or an irregular shaped configuration.

9. The automatically-activated image scanning device according to claim 1, wherein said image sensor comprises a charge-coupled device (CCD) sensor, a complementary metal-oxide-semiconductor (CMOS) sensor or a contact image sensor.
